(19) United States
(12) Patent Application Publication
(10) Pub. No.: US 2025/0277528 A1
(43) Pub. Date: Sep. 4, 2025

(54) RADIAL SHAFT SEALING RING

(71) Applicant: AKTIEBOLAGET SKF, GOTEBORG (SE)

(72) Inventors: Hans-Dieter ZANDER, Köln (DE); Maria ORTH, Leichlingen (DE)

(21) Appl. No.: 19/058,443

(22) Filed: Feb. 20, 2025

(30) Foreign Application Priority Data
Mar. 1, 2024 (DE) 102024201948.8

(51) Int. Cl. F16J 15/3284

(52) U.S. Cl. CPC F16J 15/3284

(57) ABSTRACT

A radial shaft sealing ring has a metal support ring and an elastomer part with a scaling lip resting at least partially on a rotating component. The elastomer part at least partially surrounds the support ring. The support ring has a first surface, which is free of the elastomer part, faces the exterior space and to which an element can be attached.

### CROSS-REFERENCE

This application claims priority to German patent application no. 102024201948.8 filed on Mar. 1, 2024, the contents of which are fully incorporated herein by reference.

### BACKGROUND OF THE INVENTION

The present invention relates to seals, and more particularly to a radial shaft sealing ring.

Radial shaft sealing rings can be used in various applications, such as in electric motors, to seal a rotating component, e.g. a shaft, which is arranged within a stationary component, e.g. a housing, from an exterior space. Such radial shaft sealing rings usually comprise a first sealing element that seals against the rotating component and a second sealing element that seals against the stationary component. The first sealing element rests on the rotating component, e.g. the shaft, and seals against it.

The first and second sealing elements are usually formed in one piece from an elastomer material and molded onto a support ring or support body. The support ring is more or less completely encased in the elastomer part and is thus insulated, which makes it impossible to conduct away electrical currents through the radial shaft sealing ring. Furthermore, by encasing the support ring in the elastomer part, it is not possible to provide additional elements on the support ring, as the elastomer part does not provide a stable base for attaching elements.

### SUMMARY OF THE INVENTION

It is therefore the object of the present invention to provide a radial shaft sealing ring that enables the support ring of the radial shaft sealing ring to come into contact with other elements, in particular enables them to be attached to the support ring.

This object is achieved by a radial shaft sealing ring comprising a metal support ring having a first surface and an elastomer part partially surrounding the support ring and including a sealing lip resting at least partially on a rotating component e.g., a shaft. The first surface of the support ring is free of the elastomer part, faces an exterior space and is configured for attachment of an element.

In previous radial sealing rings, the support ring is entirely surrounded by the elastomer part both on the side facing the interior space and the side facing the exterior space. Thereby, the elastomer part prevents other elements from being attached to the support ring, as described above. To overcome this problem, the support ring of the radial shaft sealing ring described here has a first surface that is free of the elastomer part and faces the exterior space. Another element can be attached to this free surface. This element can be an additional sealing lip, an electrically conductive element, a thermally conductive element or similar components or devices.

In contrast to the elastomer part, the first free surface of the support ring represents a stable contact surface to which any desired elements may be attached. Such elements can in turn contact other elements located within the exterior space (electrically or thermally conductive elements, etc.) or seal them off from the exterior space (sealing lips, etc.).

According to one embodiment, the element is fastened to the support ring, in particular glued thereto. Alternatively, the element can also be welded to the support ring or connected to it in another appropriate manner. The element may also form part of the radial shaft sealing ring.

According to another embodiment, the support ring has a second surface free of the elastomer part in order to contact a stationary component, e.g. a housing. Providing the second free surface has the advantage that, for example, in the case of an electrically conductive element, a current path is formed via the element, the first free surface, the support ring, the second free surface and the stationary component, via which current path electrical charge can be conducted away. Additional current-conducting elements or inserts in the elastomer part are not required.

As already described, the element can be an electrically conductive element. Alternatively, the element may also be a thermally conductive element for dissipating heat.

The electrically conductive element preferably extends from the support ring to an element of an electric motor, for example the shaft of the electric motor or brushes in a stator-rotor arrangement of the electric motor.

According to another embodiment, the electrically conductive element is formed of a flexible conductive material. Such a flexible conductive element provides the advantage that the electrically conductive element can contact the shaft of the electric motor, for example, without being sheared or torn off by frictional forces when the shaft rotates. In the case of a stable, fixed clement, the rotation of the shaft may result in excessive frictional force, which could lead to damage or breakage.

The flexible conductive material can, for example, comprise a conductive polymer, in particular polyethylene, polyaniline, polyparaphenylene and/or polypyrrole, and/or metal or metallic material. Other materials that are flexible and conductive are also possible. These include, for example, polytetrafluoroethylene (PTFE) with conductive fillers (e.g. carbon), non-woven materials with conductive materials such as copper, or other materials.

According to another embodiment, the support ring has through-holes in which the material of the elastomer part is arranged or disposed. These through-holes can be punched into the support ring, for example in a stamping operation. Preferably, the through-holes extend from the interior space to the exterior space. In this way, the material of the elastomer part can be transported or flow from one side of the support ring to the other side of the support ring through the through-holes during overmolding. With previous support rings, the elastomer material was filled in when the support ring was overmolded and flowed onto all sides of the support ring, thus completely encasing it.

This is no longer necessary due to the through-holes. If the elastomer material is filled in at one end and on one side of the support ring, it can also pass through the through-holes to the other side without needing to be completely encased. To ensure that the first free surface remains free of the elastomer material, for example, a corresponding mold can be used, wherein this surface lies against the mold so that no elastomer material can reach this surface.

According to another embodiment, the support ring has indentations on the side facing the interior space and corresponding protrusions or lugs on the side facing the exterior space (i.e., exterior to the bearing). These protrusions form the first free surface. This combination of protrusions and indentations can be produced by beading or embossing. The elastomer material can flow between the protrusions or embossings during production, with the protrusions remaining free. This therefore provides a simple way to make a free surface available.

It should be noted that the through-holes can also be implemented in combination with the indentations/protrusions. Furthermore, it is possible to form the free surface by removing elastomer material from the support ring.

According to another embodiment, the sealing lip has sealing structures or a spring element. The sealing structures can be sealing grooves or similar, for example, which are in contact with the rotating component and seal against it. If only a sealing lip is used instead of such sealing structures, a spring element can be provided that presses the sealing lip in the direction of the rotating component.

According to another embodiment, the sealing lip can comprise a PTFE material (i.e., polytetrafluoroethylene). In particular, the sealing lip can be coated with such a PTFE material. The PTFE material allows the sealing lip to slide better over the rotating component as it rotates, which reduces wear on the sealing lip.

Further advantages and advantageous embodiments are provided in the description, the drawings and the claims. In particular, the combinations of features provided in the description and in the drawings are purely exemplary, and therefore the features can also be present individually or in other combinations.

### BRIEF DESCRIPTION OF THE SEVERAL VIEWS OF THE DRAWINGS

In the following, the invention is described in more detail with reference to exemplary embodiments shown in the drawings. The exemplary embodiments and the combinations shown in the exemplary embodiments are purely exemplary and are not intended to define the scope of protection of the invention. The scope of protection is defined solely by the independent and dependent claims.

In the drawings:

FIG. 1 shows a schematic sectional view of a radial shaft sealing ring according to a first embodiment;

FIG. 2 shows a schematic sectional view of a radial shaft sealing ring according to a second embodiment;

FIG. 3 shows a schematic sectional view of a radial shaft sealing ring according to a third embodiment; and

FIG. 4 shows a schematic sectional view of a radial shaft sealing ring from FIG. 2 with an attached element.

### DETAILED DESCRIPTION OF THE INVENTION

In the following description, identical or functionally equivalent elements are labelled with the same reference signs.

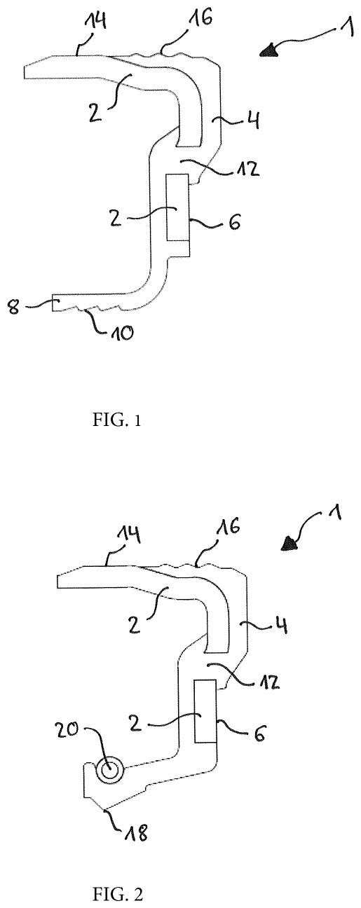

FIG. 1 shows a radial shaft sealing ring 1, which can be used to seal an interior space in relation to an exterior space, for example interior and exterior relative to a bearing or a machine. In particular, the radial shaft sealing ring 1 can be arranged between a rotating component, e.g. a shaft, and a stationary component, e.g. a housing.

The radial shaft sealing ring 1 has a metal support ring 2 and an elastomer part 4. The elastomer part 4 includes a sealing lip 8, which rests at least partially on, or is disposed against, the rotating component. The sealing lip 8 can have sealing structures 10, for example, in order to improve the sealing effect in relation to the rotating component. As can be seen in the figures, the elastomer part 4 at least partially surrounds the support ring 2.

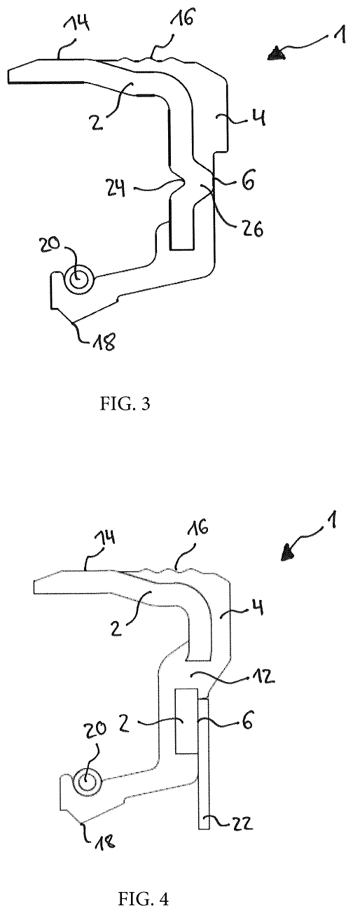

In order to provide a way of attaching additional elements to the support ring 2, in contrast to previous radial shaft sealing rings, the support ring 2 has a first surface 6 that is free of the elastomer part 4. This surface faces the exterior space. The flexible elastomer part 4 does not provide a stable surface for attaching additional elements, whereas the free surface 6 of the support ring 2 provides a stable surface to which further elements 22 (shown in FIG. 3) can be attached without any problems; i.e., the free first surface 6 is configured for attachment of the element 22. The attachment of the element 22 to the first surface 6 may be done, for example, by gluing, welding or any other appropriate attachment means or methods.

The support ring 2 has a plurality of through-holes 12, which extend from the exterior space (on the right in the figure) to the interior space (on the left in the figure). These through-holes 12 reduce the weight of the support ring 2, and therefore also the radial shaft sealing ring 1, as the ring 2 has less material when provided with the through-holes 12. Furthermore, the elastomer material can be filled in from one side of the support ring 2 during the production of the radial shaft sealing ring 1 and can pass through the through-holes 12 to the other side of the support ring 2 without having to flow around the entire support ring 2. Among other things, this means that the surface 6 of the support ring 2 can remain free (i.e., uncovered), as the elastomer material is not required to flow along or over the surface 6.

As shown in the embodiment of FIG. 2, instead of the sealing lip 8 with the sealing structures 10, a sealing lip 18 can also be provided that is pressed onto the rotating component via a spring element 20. The other features of the radial shaft sealing ring 1 of FIG. 2 correspond to the radial shaft sealing ring 1 of FIG. 1.

In another embodiment depicted in FIG. 3, the support ring 2 has indentations 24 on the side of the ring 2 facing the interior space. These indentations 24 lead to corresponding protrusions or lugs 26 on the opposite side facing the exterior space. These indentations 24 and protrusions 26 can be formed by beading or embossing. Other methods for forming these indentations 24 and protrusions 26 are also possible. In this embodiment, the protrusions 26 form or provide the first free surface 6.

When overmolding or encapsulating the support ring 2 with the elastomer material, the material can flow between the protrusions 26. Although the elastomer material in this embodiment does not flow to the other side of the ring 2 facing the interior space, the elastomer material can move between the protrusions 26 along the support ring 2 and cover sections of the ring 2 while leaving the protrusions 26 uncovered. This has the advantage that the elastomer part 4 is arranged around the support ring 2, with the protrusions 26 remaining free and forming the first free surface 6.

It should be noted that the embodiments from FIGS. 1 and 2 are also included in FIG. 3. Furthermore, the sealing lip 8 from FIG. 1 can also be provided in the support ring 2 of FIG. 3 instead of the sealing lip 18 as depicted in FIG. 3. It should furthermore be noted that the free surface 6 can also be formed by removing a portion of the elastomer material 4.

As will now be described with reference to FIG. 4, an element 22 can be arranged on or disposed against the first free surface 6 of the support ring 2. It should be noted that although FIG. 4 shows the embodiment of FIG. 2, the features described with reference to FIG. 4 also apply to the embodiments of FIGS. 1 and 3.

For example, the element 22 can be an electrically conductive element. Such a conductive element 22 may, for example, contact the rotating component to serve as a current-conducting element. As shown in FIGS. 1 to 4, the support ring 2 can have a second free surface 14, which may contact the stationary component, for example a housing. With such a second free surface 14, a current path or conductive path may be formed from or between the rotating component via the element 22, the first free surface 6, the support ring 2, the second free surface 14 and the stationary component.

In addition, the radial shaft sealing ring 1 may rest against the stationary component by means of the elastomer part 4, in particular by a sealing structure 16. This sealing structure 16 improves the seal between the stationary and rotating components.

In summary, the proposed radial shaft sealing ring 1 provides an option to securely and stably attach additional elements 22, e.g. electrically conductive elements, to the radial shaft sealing ring 1 via the elastomer-free first surface 6.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### LIST OF REFERENCE SIGNS

1 Radial shaft scaling ring
2 Support ring
4 Elastomer part
6 First free surface
8 Scaling lip
10 Scaling structure
12 Through-holc
14 Second free surface
16 Scaling structure
18 Scaling lip
20 Spring clement
22 (Electrically conductive) clement
24 Indentation
26 Protrusion

We claim:

1. A radial shaft sealing ring comprising:
a metal support ring having a first surface; and
an elastomer part partially surrounding the support ring and including a sealing lip resting at least partially on a rotating component;
wherein the first surface of the support ring is free of the elastomer part, faces an exterior space and is configured for attachment of an element to the support ring.

2. The radial shaft sealing ring according to claim 1, wherein the radial shaft sealing ring further comprises the element fastened to the support ring.

3. The radial shaft sealing ring according to claim 2, wherein the element is fastened by glue to the support ring.

4. The radial shaft sealing ring according to claim 1, wherein the support ring further has a second surface free of the elastomer part and contactable with a stationary component.

5. The radial shaft sealing ring according to claim 1, wherein the element is an electrically conductive element.

6. The radial shaft sealing ring according to claim 5, wherein the electrically conductive element extends from the support ring to an element of an electric motor.

7. The radial shaft sealing ring according to claim 5, wherein the electrically conductive element is formed of a flexible conductive material.

8. The radial shaft sealing ring according to claim 7, wherein the flexible conductive material is a conductive polymer and/or a metal.

9. The radial shaft sealing ring as recited in claim 8, wherein the conductive polymer includes polyethylene, polyaniline, polyparaphenylene and/or polypyrrole.

10. The radial shaft sealing ring according to claim 1, wherein the support ring has a plurality of through-holes and a separate portion of the elastomer part is disposed within each one of the through-holes.

11. The radial shaft sealing ring according to claim 1, wherein the support ring has indentations on a side facing an interior space of the bearing unit and corresponding protrusions on a side facing the exterior space, and wherein the protrusions form the first free surface.

12. The radial shaft sealing ring according to claim 1, wherein the sealing lip has sealing structures or a spring element.
